(19) United States
(12) Patent Application Publication
(10) Pub. No.: US 2017/0086077 A1
(43) Pub. Date: Mar. 23, 2017

(54) METHOD, APPARATUS AND SYSTEM

(71) Applicant: NOKIA SOLUTIONS AND NETWORKS OY, Espoo (FI)

(72) Inventors: Yong TENG, Beijing (CN); Kari Veikko HORNEMAN, Oulu (FI); Ling YU, Kauniainen (FI)

(73) Assignee: NOKIA SOLUTIONS AND NETWORKS OY, Espoo (FI)

(21) Appl. No.: 15/311,387

(22) PCT Filed: May 16, 2014
(86) PCT No.: PCT/EP2014/060098

§ 371 Date: Nov. 15, 2016

(51) Int. Cl. H04W 16/14; H04W 28/08; H04W 28/02

(52) U.S. Cl. CPC H04W 16/14; H04W 28/0236; H04W 28/08

(57) ABSTRACT

A method includes determining, for a first network, first activity information for shared usage of a first portion of a spectrum allocated to the first network with at least one second network and causing the activity information to be sent to at least one base station of said second network.

### FIELD

The present application relates to a method, apparatus and system and in particular but not exclusively, co-primary spectrum sharing.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communications may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless communication system at least a part of communications between at least two stations occurs over a wireless link. Examples of wireless systems include public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3^{rd} Generation Partnership Project (3GPP). The various development stages of the 3GPP LTE specifications are referred to as releases. The aim of the standardization is to achieve a communication system with, inter alia, reduced latency, higher user data rates, improved system capacity and coverage, and reduced cost for the operator.

### SUMMARY

In a first aspect there is provided a method comprising determining, for a first network, first activity information for shared usage of a first portion of a spectrum allocated to the first network with at least one second network and causing the activity information to be sent to at least one base station of said second network.

The first network may be operated by a first operator of a plurality of operators.

The at least one second network may be operated by a second operator of the plurality of operators

The first portion may be an inter-operator sharing portion.

The spectrum allocated to the first network may comprise a second portion.

The second portion is an intra-operator sharing portion.

The method may comprise causing shared usage of the intra-operator portion with the at least one second network in dependence of a request from the second network.

The allocated spectrum may be used for co-primary spectrum sharing.

Determining activity information may comprise selecting an activity indicator from a set of activity indicators.

The method may comprise determining activity information in dependence of cell density.

The method may comprise determining activity information in dependence of at least one of relative traffic volumes of a cell and interference levels of a cell.

The activity information may be static.

The method may be carried out at a spectrum controller.

The activity information may be dynamic

The method may be carried out at a base station.

The spectrum allocated to the first network may comprise a third portion.

The third portion may lie between the first and second portion.

In a second aspect there is provided a method comprising receiving first activity information associated with a first network and determining, for a first portion of a spectrum shared between said first network and at least one second network, if said second network is to change said share of said spectrum in dependence of said activity information.

The method may comprise receiving second activity information associated with the first network comparing the second activity information with the first activity information and determining, for a first portion of a spectrum shared between said first network and at least one second network, if said second network is to change said share of said spectrum in dependence of said comparison.

The method may comprise causing a request to be sent to the first network for a change in said share of said spectrum

The first portion of the spectrum may be at least a portion of an inter-operator sharing portion.

The first portion of the spectrum may be at least a portion of an intra-operator sharing portion.

The method may comprise receiving activity information from a spectrum controller, or a base station of the first network.

The activity information may be static or dynamic.

The method may comprise requesting selection of a second portion of the spectrum shared between the first network and the second network.

The method may comprise receiving a request to stop using the second portion of the spectrum.

The second portion may comprise at least a portion of an intra-operator sharing part.

The activity information may be dependent on cell density.

The activity information may be dependent on at least one of relative traffic volumes of a cell and interference levels of a cell.

In a third aspect there is provide an apparatus, said apparatus having means for determining, for a first network, first activity information for shared usage of a first portion of a spectrum allocated to the first network with at least one second network and causing the activity information to be sent to at least one base station of said second network.

The first network may be operated by a first operator of a plurality of operators.

The at least one second network may be operated by a second operator of the plurality of operators

The first portion may be an inter-operator sharing portion.

The spectrum allocated to the first network may comprise a second portion.

The second portion is an intra-operator sharing portion.

The apparatus may comprise means for causing shared usage of the intra-operator portion with the at least one second network in dependence of a request from the second network.

The allocated spectrum may be used for co-primary spectrum sharing.

Determining activity information may comprise selecting an activity indicator from a set of activity indicators.

The apparatus may comprise means for determining activity information in dependence of cell density.

The apparatus may comprise means for determining activity information in dependence of at least one of relative traffic volumes of a cell and interference levels of a cell.

The activity information may be static.

The apparatus may be comprised at a spectrum controller.

The activity information may be dynamic

The apparatus may be comprised at a base station.

The spectrum allocated to the first network may comprise a third portion.

The third portion may lie between the first and second portion.

In a fourth aspect there is provided an apparatus said apparatus comprising means for receiving first activity information associated with a first network and determining, for a first portion of a spectrum shared between said first network and at least one second network, if said second network is to change said share of said spectrum in dependence of said activity information.

The apparatus may comprise means for receiving second activity information associated with the first network comparing the second activity information with the first activity information and determining, for a first portion of a spectrum shared between said first network and at least one second network, if said second network is to change said share of said spectrum in dependence of said comparison.

The apparatus may comprise means for causing a request to be sent to the first network for a change in said share of said spectrum

The first portion of the spectrum may be at least a portion of an inter-operator sharing portion.

The first portion of the spectrum may be at least a portion of an intra-operator sharing portion.

The apparatus may means for receiving activity information from a spectrum controller, or a base station of the first network.

The activity information may be static or dynamic.

The apparatus may comprise means for requesting selection of a second portion of the spectrum shared between the first network and the second network.

The apparatus may comprise means for receiving a request to stop using the second portion of the spectrum.

The second portion may comprise at least a portion of an intra-operator sharing part.

The activity information may be dependent on cell density.

The activity information may be dependent on at least one of relative traffic volumes of a cell and interference levels of a cell.

In a fifth aspect there is provided a computer program product for a computer, comprising software code portions for performing the steps of the methods described above when said product is run on the computer.

In a sixth aspect there is provided an apparatus comprising at least one processor and at least one memory including a computer program code, the at least one memory and the computer program code configured to, with the at least one processor, cause the apparatus at least to: determine, for a first network, first activity information for shared usage of a first portion of a spectrum allocated to the first network with at least one second network and cause the activity information to be sent to at least one base station of said second network operated by one of the plurality of operators.

The first network may be operated by a first operator of a plurality of operators.

The at least one second network may be operated by a second operator of the plurality of operators

The first portion may be an inter-operator sharing portion.

The spectrum allocated to the first network may comprise a second portion.

The second portion is an intra-operator sharing portion.

The at least one memory and the computer program code may be configured to, with the at least one processor, cause the apparatus to cause shared usage of the intra-operator portion with the at least one second network in dependence of a request from the second network.

The allocated spectrum may be used for co-primary spectrum sharing.

Determining activity information may comprise selecting an activity indicator from a set of activity indicators.

The at least one memory and the computer program code may be configured to, with the at least one processor, cause the apparatus to determine activity information in dependence of cell density.

The at least one memory and the computer program code may be configured to, with the at least one processor, cause the apparatus to determine activity information in dependence of at least one of relative traffic volumes of a cell and interference levels of a cell.

The activity information may be static.

The apparatus may be comprised at a spectrum controller.

The activity information may be dynamic

The apparatus may be comprised at a base station.

The spectrum allocated to the first network may comprise a third portion.

The third portion may lie between the first and second portion.

In a seventh aspect there is provided an apparatus comprising at least one processor and at least one memory including a computer program code, the at least one memory and the computer program code configured to, with the at least one processor, cause the apparatus at least to: receive first activity information associated with a first network and determine, for a first portion of a spectrum shared between said first network and at least one second network, if said second network is to change said share of said spectrum in dependence of said activity information.

The at least one memory and the computer program code may be configured to, with the at least one processor, cause the apparatus to receive second activity information associated with the first network comparing the second activity information with the first activity information and determining, for a first portion of a spectrum shared between said first network and at least one second network, if said second network is to change said share of said spectrum in dependence of said comparison.

The at least one memory and the computer program code may be configured to, with the at least one processor, cause the apparatus to cause a request to be sent to the first network for a change in said share of said spectrum

The first portion of the spectrum may be at least a portion of an inter-operator sharing portion.

The first portion of the spectrum may be at least a portion of an intra-operator sharing portion.

The at least one memory and the computer program code may be configured to, with the at least one processor, cause the apparatus to receive activity information from a spectrum controller, or a base station of the first network.

The activity information may be static or dynamic.

The at least one memory and the computer program code may be configured to, with the at least one processor, cause the apparatus to request selection of a second portion of the spectrum shared between the first network and the second network.

The at least one memory and the computer program code may be configured to, with the at least one processor, cause the apparatus to receive a request to stop using the second portion of the spectrum.

The second portion may comprise at least a portion of an intra-operator sharing part.

The activity information may be dependent on cell density.

The activity information may be dependent on at least one of relative traffic volumes of a cell and interference levels of a cell.

In an eighth aspect there is provided a computer program embodied on a computer-readable storage medium, the computer program comprising program code for controlling a process to execute a process, the process comprising: determining, for a first network, first activity information for shared usage of a first portion of a spectrum allocated to the first network with at least one second network and causing the activity information to be sent to at least one base station of said second network operated by one of the plurality of operators.

The first network may be operated by a first operator of a plurality of operators.

The at least one second network may be operated by a second operator of the plurality of operators

The first portion may be an inter-operator sharing portion.

The spectrum allocated to the first network may comprise a second portion.

The second portion is an intra-operator sharing portion.

The method may comprise causing shared usage of the intra-operator portion with the at least one second network in dependence of a request from the second network.

The allocated spectrum may be used for co-primary spectrum sharing.

Determining activity information may comprise selecting an activity indicator from a set of activity indicators.

The process may comprise determining activity information in dependence of cell density.

The process may comprise determining activity information in dependence of at least one of relative traffic volumes of a cell and interference levels of a cell.

The activity information may be static.

The process may be carried out at a spectrum controller.

The activity information may be dynamic

The process may be carried out at a base station.

The spectrum allocated to the first network may comprise a third portion.

The third portion may lie between the first and second portion.

In a ninth aspect there is provided a computer program embodied on a computer-readable storage medium, the computer program comprising program code for controlling a process to execute a process, the process comprising: receiving first activity information associated with a first network and determining, for a first portion of a spectrum shared between said first network and at least one second network, if said second network is to change said share of said spectrum in dependence of said activity information.

The process may comprise receiving second activity information associated with the first network comparing the second activity information with the first activity information and determining, for a first portion of a spectrum shared between said first network and at least one second network, if said second network is to change said share of said spectrum in dependence of said comparison.

The process may comprise causing a request to be sent to the first network for a change in said share of said spectrum

The first portion of the spectrum may be at least a portion of an inter-operator sharing portion.

The first portion of the spectrum may be at least a portion of an intra-operator sharing portion.

The process may comprise receiving activity information from a spectrum controller, or a base station of the first network.

The activity information may be static or dynamic.

The process may comprise requesting selection of a second portion of the spectrum shared between the first network and the second network.

The process may comprise receiving a request to stop using the second portion of the spectrum.

The second portion may comprise at least a portion of an intra-operator sharing part.

The activity information may be dependent on cell density. The activity information may be dependent on at least one of relative traffic volumes of a cell and interference levels of a cell.

In the above, many different embodiments have been described. It should be appreciated that further embodiments may be provided by the combination of any two or more of the embodiments described above.

### LIST OF DRAWINGS

Some embodiments will now be described, by way of example only, with reference to the accompanying Figures in which:

FIG. 1 shows a schematic diagram of an example communication system comprising a base station and a plurality of communication devices;

FIG. 2 shows a schematic diagram, of an example mobile communication device;

FIG. 3 shows a flowchart of an example of a method of determining an activity indicator;

FIG. 4 shows a flow chart of an example of a method of spectrum sharing;

FIG. 5 shows an example of usage of an activity indicator in spectrum sharing;

FIG. 6 shows a schematic diagram of an example control apparatus;

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain also features, structures, units, modules etc. that have not been specifically mentioned.

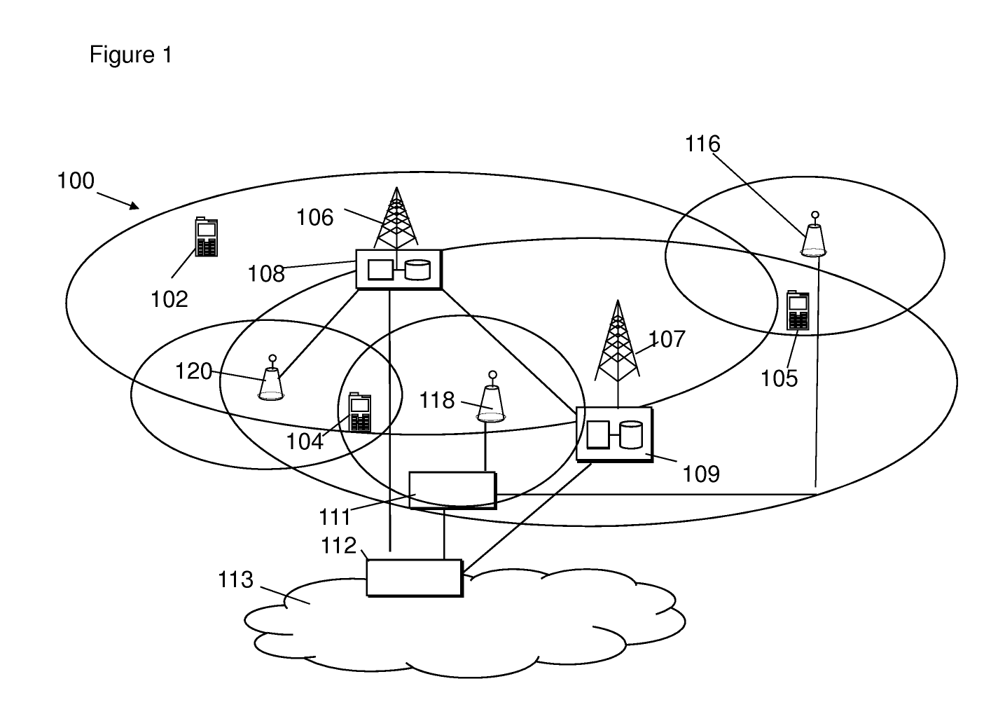

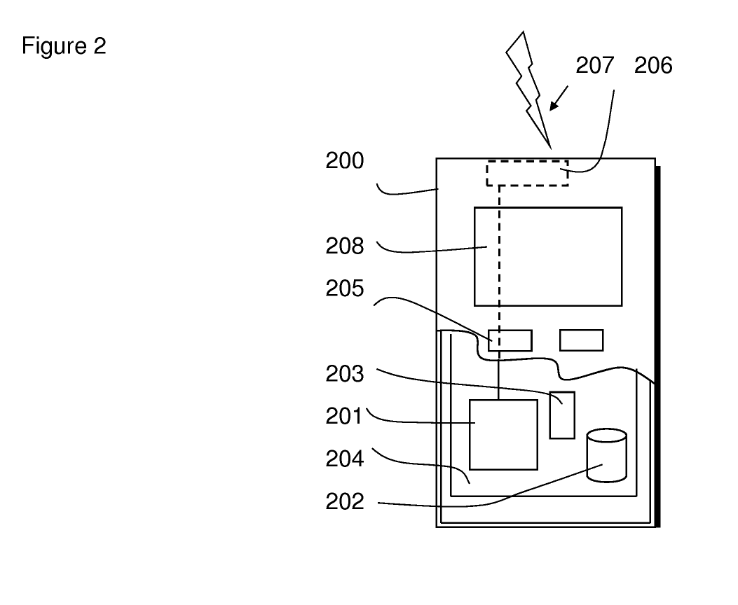

Before explaining in detail some examples, certain general principles of a wireless communication system and mobile communication devices are briefly explained with reference to FIGS. 1 to 2 to assist in understanding the technology underlying the described examples. The system architecture used in Figures is not limiting, but should be taken only as an example. Therefore, all words and expressions should be interpreted broadly and they are intended to illustrate, not to restrict, embodiments.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (not shown) and may be implemented as one central apparatus or its functionality may be distributed over several apparatus. The controller apparatus may be part of the base station (and/or provided by a separate entity such as a Radio Network Controller). In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. It should be appreciated that at least some of the network functionalities or services may also be carried out cloud-service assisted.

LTE or LTE-Advanced systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations or nodes 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible mobile communication device (user device) will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples include a mobile station (MS) or mobile device such as a mobile phone or what is known as a ‘smart phone’, a computer provided with a wireless interface card or other wireless interface facility (e.g., USB dongle), personal data assistant (PDA), tablet, phablet, laptop, and/or touch screen computer, device using a wireless modem (alarm or measurement device, etc.) provided with wireless communication capabilities or any combinations of these or the like. It should be appreciated that a user device may also be a nearly exclusive uplink only device, of which an example is a camera or video camera loading images or video clips to a network.

A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Radio Link Control/Medium Access Control/Physical layer protocol (RLC/MAC/PHY) and control plane Radio Resource Control (RRC) protocol terminations towards the communication devices. Other examples of radio access system include those provided by base stations of systems that are based on technologies such as wireless local area network (WLAN) and/or WiMax (Worldwide Interoperability for Microwave Access). A base station can provide coverage for an entire cell or similar radio service area.

Cells can provide different service areas. For example, some cells may provide wide coverage areas while some other cells provide smaller coverage areas. The smaller radio coverage areas can be located wholly or partially within a larger radio coverage area. For example, in LTE a node providing a relatively wide coverage area is referred to as a macro eNode B. Examples of nodes providing smaller cells, or local radio service areas, include femto nodes such as Home eNBs (HeNB), pico nodes such as pico eNodeBs (pico-eNB) and remote radio heads.

The disclosure relates to wireless communication systems, such as 3GPP LTE-advanced, or beyond (5^{th} generation, 5G), with cognitive radio (CR) aspects, which is a potential feature in future release. In particular, the disclosure relates to co-primary spectrum sharing as a flexible spectrum management and dynamic access schemes in cognitive radio technology.

Co-primary spectrum sharing refers to a spectrum access model where two or more primary license holders (of the same Radio Service) agree on joint use of parts of their licensed spectrum. The exact usage conditions (policies) may be laid down in a mutual agreement and the model may be subject to permission by the national regulator.

A similar access model would be where a regulator allocates a part of spectrum not to a single operator exclusively, but jointly to several potential users (operators) with the obligation to use it collectively under fair conditions and subject to certain rules. Such a mode has been discussed e.g. by the German Regulator (formerly RegTP) regarding allocation of 3.5 GHz band for Fixed BWA in 2004/5. A similar concept was also created by the FCC 2007 rules for a novel “light licensing” scheme in the 3650-3700 MHz band which for example resulted to the creation of the IEEE 802.11y standard.

The co-primary spectrum sharing is an advance from the ASA spectrum sharing concept, which is in the promotion phase among key players of telecommunication regulation, standardization and industry. The co-primary spectrum sharing will provide more dynamic spectrum sharing between operators providing the same radio services whereas the ASA is targeted for spectrum sharing of some incumbent user.

Coordination among different operators may be problematic. Extensive and comprehensive coordination may increase the complexity of the interface between operators. Operators may not be willing to distribute sensitive information on their networks. So a reasonable mechanism for inter-operator sharing is desirable.

Interest in flexible spectrum usage (FSU) has focused on intra-operator spectrum sharing between different cells. Inter-system spectrum sharing has looked at two involved systems, defined as primary system and secondary system separately, and having different priorities to use the shared spectrum. A large number of studies about cognitive radio are all related to this topic. Coordination between operators via non-sensitive/simple information exchange for co-primary spectrum sharing has not been investigated in depth.

Co-primary sharing access mode together with cognitive radio access procedures can enable higher peak data rates for the end users as well as higher capacity. Such shared spectrum usage seems especially beneficial and appropriate for small cell deployments because these are usually more isolated than large macro cells.

In an embodiment, a co-primary spectrum sharing mechanism based on an activity indicator is proposed.

In an embodiment, it is proposed that a shared spectrum band is divided between operators so that for each operator there will be provided a certain amount of spectrum. The spectrum may be divided equally amount or unequally between operators. The division of the spectrum may be dependent on licensing rules. The division of the spectrum may be predefined. The division of the spectrum may be altered dependent on the licensing rules.

The spectrum band for each operator may be further divided. The division of the spectrum band provided to an operator may be predefined. The division of the spectrum may be altered dependent on the licensing rules. For example, the spectrum band for each operator may be divided into two parts; one mainly for intra-operator sharing (second portion) and one mainly for inter-operator sharing (first portion). The sizes of the part may depend on the license rules and may vary in time and location. Operators may donate both the intra-operator and the inter-operator parts for use by other operators so that there might be different rules to other operators to use the donated parts depending on from which parts they have been donated. For example, if the donation part is from the intra-operator part the donating operator may have higher priority to claim back the donating part and the other operators may have to explicitly request to use the donation part, but if the donation part is from the inter-operator part the other operators may autonomously use the donation part (i.e without permission from the donating operator) based on activity indicator based coordination mechanism as proposed.

As another example, the divided spectrum may comprise three zones: one is an intra-operator (second portion), which is mainly targeted to be used to solve intra-operator sharing and also interference mitigation within the operator's network. Another zone is an inter-operator zone (first portion), which is mainly for inter-operator sharing and also interference mitigation between operators' networks. In between the intra-operator and inter-operator zones, there may be provided an intermediate zone or third portion which allows cells to have similar levels of both intra-operator sharing optimization and inter-operator sharing optimization. The donation part of the spectrum may be divided into sub-parts, for example component carriers, which could be ordered for co-ordination purposes when operators are using the donated parts.

To facilitate the coordination on the use of the donation part of the spectrum among different operators, it is proposed that a certain form of an activity indicator may be indicated by spectrum controller or broadcasted by macro or local cells of each operator.

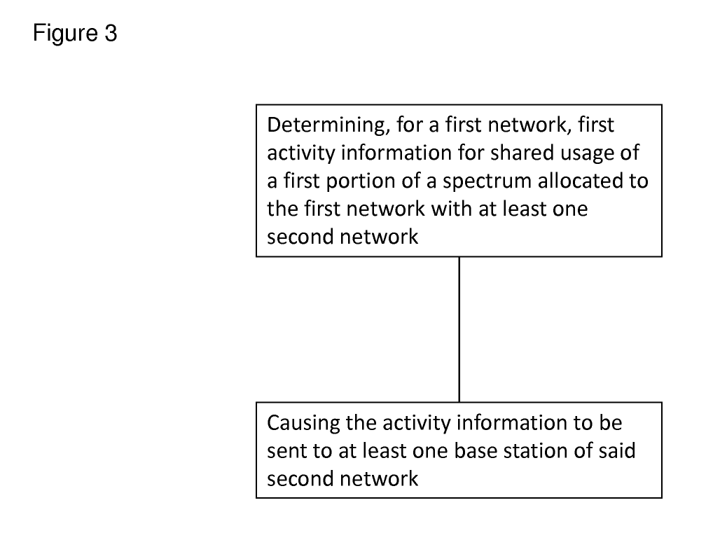

As shown in FIG. 3, for a first network, first activity information may be determined for shared usage of a first portion of a spectrum allocated to the first network with at least one second network. The activity information may be caused to be sent to at least one base station of said second network. The second network may be operated by an operator other than that operating the first network.

The activity information may comprise an activity indicator. The type of activity indicator may be predefined based on the time of a day and/or location. Based on the type of the activity indicator it may be selected how to inform on the activity indicator.

The reference point for the activity indicator (i.e. location or area for which the activity is related to) may be pre-defined by operators or the rules how to determine the reference point may be pre-defined by operators. The latter option will give more flexibility for the use of the activity indicator as the reference point could be dynamically changed. The reference point information may be part of the activity indicator information.

The donation part of the spectrum may be divided into sub-parts, for example component carriers, which could be ordered for co-ordination purposes when operators are using the donated parts.

One activity indicator may be cell density level, which is a metric to indicate the density of small cell deployment, predefined as, e.g. high, medium and low, three states. As an example, the density level could be deduced through the number of cells per square meter, ratio of the number of small cells to the number of macro cell in an area etc. The density may take into account only the active small cells or be location dependent. In some regions, cell density level is sent by a small cell cluster head or just a small cell.

The activity indicator may be based on relative traffic volumes of a cell and/or interference level compared to a pre-defined term average. Depending on the preferred definition of the activity indicator, it may be static (e.g. if only cell density is taken into account) or it may change dynamically (e.g. if traffic volume of each cell is also taken into account). For a static activity indicator, it may be preferable to maintain the activity indicator in a spectrum controller and indicate the activity indicator to the relevant local area during deployment by spectrum controller when needed. If the activity indicator is dynamic, it may be preferable for the activity indicator to be broadcast by local cells to trigger spectrum coordination to respond to the change of activity in each operator's network.

It is proposed that the activity indicator is used for the coordination on the use of inter-operator donation part of spectrum among different operators.

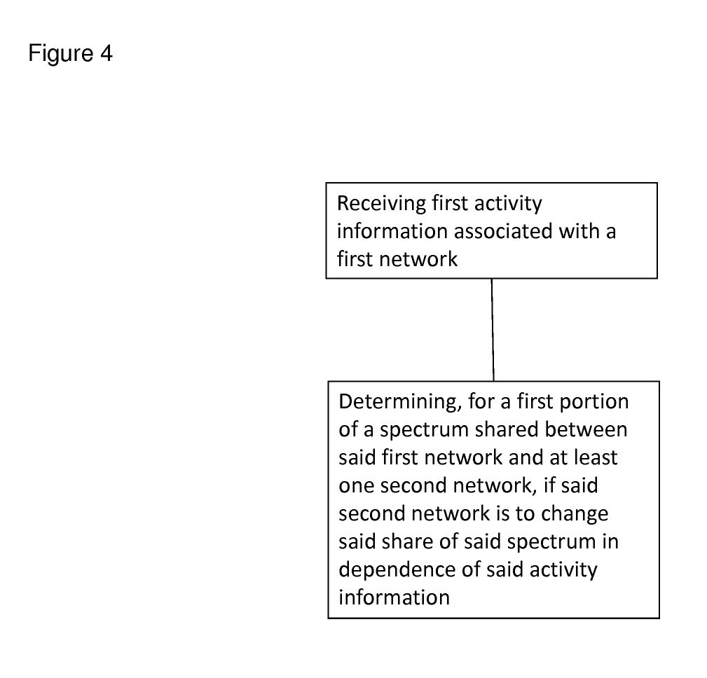

As shown in FIG. 4, an example of a method for coordinating spectrum sharing between different networks may comprise receiving first activity information associated with a first network and determining, for a first portion of a spectrum shared between said first network and at least one second network, if said second network is to change said share of said spectrum in dependence of said activity information. The networks may be operated by different operators. The first portion of the spectrum may be an intra-operator part or an inter-operator part.

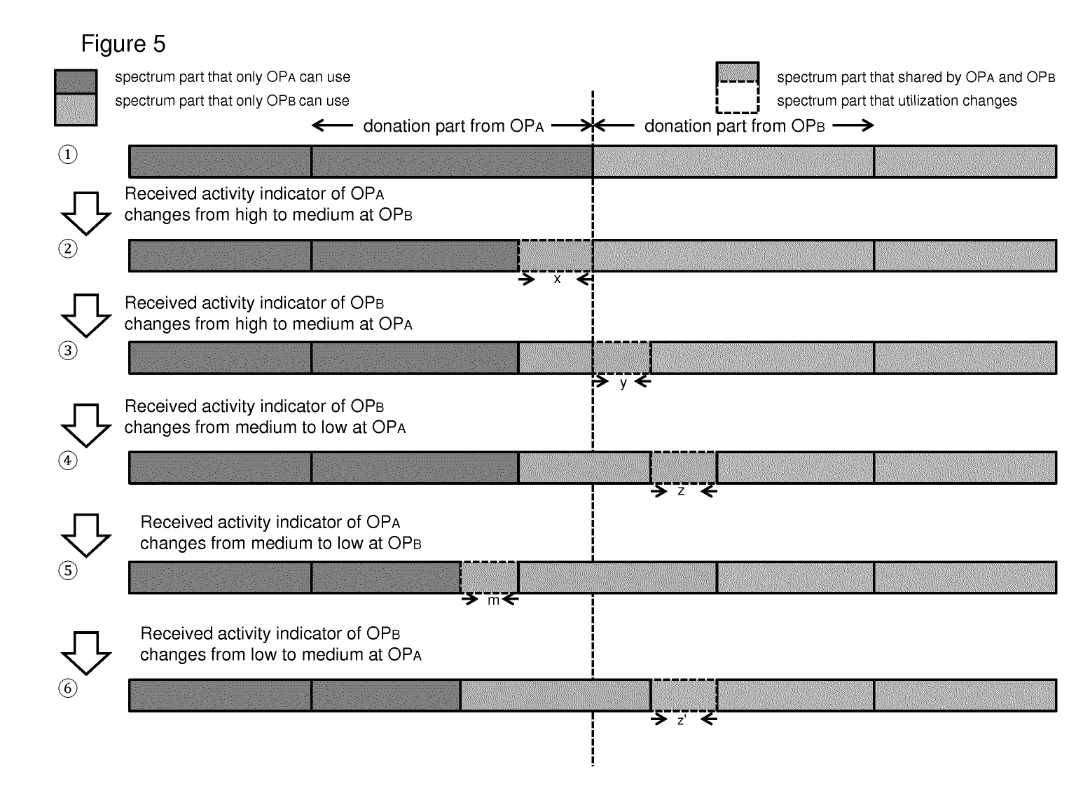

One example is now discussed by means of FIG. 5. Operator B may receive activity information in the form of an activity indicator from operator A (either via indication from spectrum controller or broadcast from cells), the indicator may then be compared with previous information from operator A to judge the updated situation for operator A. If the activity indicator of operator A changes from high to medium, operator B may try to reuse a specific amount of the sub-parts of the donated resource from operator A according to predefined rules and the cell activity status of its own (e.g. change of indicator from high to medium by operator A may relate to certain number of sub-parts to be reused by operator B when operator B's own cell activity is certain number), i.e. move the border of shared part as shown in the figure. The predefined rules may allow operator A to be aware of how many sub-parts will be used by the operator B. If the activity indicator for operator A changes from medium to high, operator B may stop using some or all of the resources from operator A and may stop using some resources of its own depending on the cell activity status of operator B. For a pair of operators, two operators' situation on the activity indicator may decide the shared part border in frequency and/or the size of the shared part, although the decision of resource usage is made individually at each operator. That is, the sharing part for a pair of operators is sliding and adjustable to be larger or smaller. The shared part border may not need to be agreed, via coordination, between the operators each time, as border for the shared spectrum portion is formed as a result of actions taken by operator A or operator B based on the opposite operator's activity situation.

For donation from the intra-operator part of the spectrum, the other operators may have to explicitly request use of the donation part. The donating operator may have higher priority to claim back the donating part either explicitly or implicitly. For example, if the donating operator has sent out positive activity indicator change e.g. from medium to high or from low to medium, then other operators will automatically stop using the donation from the intra-operator part of the spectrum. Once the donating operator has chosen to send out a negative activity indicator change e.g. from medium to low, other operator can request to use intra-operator spectrum resources. The step-size for the activity indicator change applied to donation from the intra-operator part may be predefined. The step-size for the activity indicator change applied to donation from the intra-operator part may be independent of step-size for the activity indicator change applied to donation from the inter-operator part.

As one exemplified embodiment, spectrum allocation could be carried out with intra-operator optimization in the beginning, followed by inter-operator optimization. In a region or small area, there may be a cluster head which could be a macro cell, a small cell or a specific entity. The cluster head may be in charge of the small cells within the cluster and may take responsibility for exchanging information related to the cluster with other clusters.

Each cell may have component carrier occupation based on its intra-operator knowledge. A cluster head or each cell transmits its cluster or its regional activity indicator to another operator's cell e.g. in a broadcasting manner. After receiving the information, each cell would judge e.g. based on ratio between the number of received activity indicators showing positive change and activity indicator showing negative change, and then decide to adjust its resource usage limit by at least one stepsize. Positive change is used to mean, for example, an activity indicator showing a change from medium to high or low to medium can be derived, and negative change means, for example, a change from high to medium or from medium to low can be derived from the activity information.

One option for intra-operator shared usage is a maximum clique method. In this method, the maximum clique for each node (i.e. cell) is determined first. It is defined according to topology of the network (i.e. if a node/cell is close to many nodes/cells then maximum clique is a larger number). In general, a direct mapping could be that if the maximum clique for one small cell in the graph is M, then the maximum number of component carriers which the cell could occupy is N/M, where N is total number of component carriers in the shared spectrum pool. That would maintain interference between cells in the network to be at controlled level.

Then if the cell or all the cells in the same cluster within one operator receives a positive change of activity indicator from ‘other operator’, which may mean ‘other operator’ has denser deployment than before, then the cell may consider increasing its maximum clique by a predefined step size, for example, one, so that the maximum clique for the cell is changed to M+1, and the cell can occupy N/(M+1) component carriers, i.e. the cell would release component carriers by N/M−N/(M+1).

In the following, an example describing an embodiment, wherein the donation part has been divided into sub-parts (e.g. component carriers) and the maximum clique method is used, is explained in further detail:

For example, assuming there are 6 component carriers in the spectrum pool, with intra-operator knowledge, the cell decides autonomously to occupy 3 component carriers from spectrum pool based on estimation that its maximum clique in the intra-operator topology is 2. Here an algorithm based on graph theory is applied to intra-operator topology estimation, e.g. setting up graph between small cells based on predefined rules and then getting maximum clique for each small cell. The maximum clique decides the maximum resources the cell could occupy taking interference situation based on graph setup into account [1]. A direct mapping could be that if the maximum clique for one small cell in the graph is M, then the maximum number of CCs the cell could occupy is N/M, where N is total number of component carriers in the spectrum pool. If the cell receives four positive cell density change indications and only one negative cell density change indication from neighboring cells/cluster head cells of counterpart operator, then, the cell makes decision based on predefined criteria to estimate its maximum clique to be 3 after taking into account inter-operator topology. The cell may release one component carrier and only occupy 2 component carriers, which may leave some room for other operator's cells.

As another exemplified embodiment, a spectrum controller from each operator may divide the operator parts of spectrum pool which are already occupied, or to be occupied, into three zones: one is intra-operator zone, which is mainly targeted to be used to solve intra-operator sharing and also interference mitigation within the operator. Another is inter-operator zone, which is mainly for inter-operator sharing and also interference mitigation between two operators. In between the above two zones, one zone is an intermediate zone which allows cells to have similar levels of both intra-operator sharing optimization and inter-operator sharing optimization. For example, assuming two operators agree beforehand that they will gradually utilize spectrum pool part (shared part) e.g. that OP_{A} will use spectrum pool from left CCs to right CCs while OP_{B} will use spectrum pool from right CCs to left CCs, then two operators' inter-operator zones are more likely overlapped in frequency and their intermediate zones are less likely overlapped in frequency. The probability that the intra-operator zone to be overlapping is lower or even this zone is defined as dedicated.

A predefined rule is typically needed for each cell to decide which zone he would be better to go use. For example, the cell may judge its situation within the operator based on e.g. number of neighboring cells from the same operator or maximum clique from intra-operator topology knowledge. As it can receive activity indication from other operator, the cell has also a rough estimation of its situation between operators, based on e.g. ratio between the number of received positive activity indicator change indication and negative activity indicator change. Then the cell could compare its intra-operator situation and inter-operator situation from possible metrics mentioned above and decides critical level for intra-operator situation and inter-operator situation.

For example, if the maximum clique method is used, the cell estimates its maximum clique to be 4 within the operator and ratio between the number of received positive activity indicator change indication and negative activity indicator change is quite low e.g. 0.1. So the cell considers that intra-operator sharing is much more critical than inter-operator sharing. The cell may then participate in spectrum sharing within the inter-operator zone. If the cell estimates its maximum clique to be 1 within the operator and the ratio between the number of received positive activity indicator change and negative activity indicator change is 5, then the cell may participate spectrum sharing within the intra-operator zone. And possibly in the optimization of spectrum sharing with other cells within inter-operator zone, only inter-operator situation is needed to be considered. Possibly critical level for intra-operator situation and inter-operator situation is similar and then the cell would be allocated to intermediate zone.

There may be changes on the cell's intra-operator situation and inter-operator situation based on collected metrics so that the cell may be trigged to transfer to another zone.

Embodiments provide flexible and simple operation, factors such as spectrum allocation policies and/or conditions for use may be agreed between operators prior to implementation. Embodiments are effectively scalable and can be shared between multiple operators. The signalling overhead required is not large and not sensitive to the type of operator.

The steps/points, signalling messages and related functions described above are in no absolute chronological order, and some of the steps may be performed simultaneously or in an order differing from the given one.

It should be appreciated that signalling, transmitting and/or receiving may herein mean preparing a data transmission and/or reception, preparing a message to be signalled, transmitted and/or received, controlling transmission and/or reception or physical transmission and/or reception, etc. on a case by case basis.

It should be understood that each block of the flowchart of FIG. 3 or 4 and any combination thereof may be implemented by various means or their combinations, such as hardware, software, firmware, one or more processors and/or circuitry.

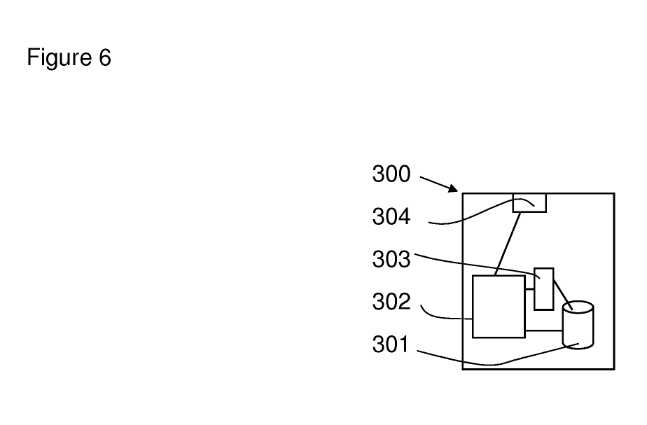

Embodiments may be implemented in or by a control apparatus, unit, module or entity as shown in FIG. 6. FIG. 6 shows an example of a control apparatus, unit, module or entity for a communication system, for example to be operationally coupled to and/or for controlling a station of an access system, such as a base station or (e) node B, or a server or host. In some embodiments, base stations comprise a separate control apparatus, unit or module. In other embodiments, the control apparatus may be another network element such as a radio network controller, spectrum controller or server. In some embodiments, each base station may have such a control apparatus (as well as a control apparatus being provided in a radio network controller). The control apparatus 109 may be arranged to provide control on communications in the service area of the system. The control apparatus 109 may comprise at least one memory 301, at least one data processing unit 302, 303 and an input/output interface 304. Via the interface the control apparatus can be operationally coupled to a receiver and a transmitter of the base station. The receiver and/or the transmitter may be implemented as a radio front end or a remote radio head. For example the control apparatus or the data processing unit may be configured to execute an appropriate software code to provide functionalities described above. The functionalities in relation to spectrum sharing may also be carried out at least partly in a cloud service assisted manner.

An example of an apparatus comprises means 302 and/or 303 for determining, for a first network, first activity information for shared usage of a first portion of a spectrum allocated to the first network with at least one second network and causing the activity information to be sent to at least one base station of said second network. The means may a computer program or a portion of a computer program.

Another example of an apparatus comprises means 302 and/or 303 for controlling receiving first activity information associated with a first network and determining, for a first portion of a spectrum shared between said first network and at least one second network, if said second network is to change said share of said spectrum in dependence of said activity information. The means may be a computer program or a portion of a computer program.

Yet another example of an apparatus may comprise means for carry out both of the above described embodiments, for instance as software modules.

It should be understood that the apparatuses may include or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE, similar principles can be applied to any other communication system where co-primary spectrum sharing is supported. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Software routines or a computer program code may be downloaded into the apparatus carrying out embodiments.

Embodiments provide computer programs embodied on a computer readable storage medium, configured to control a processor to perform embodiments of the methods described above. The computer readable storage medium may be a non-transitory medium.

Further in this regard it should be noted that any blocks of the logic flow as in the Figures described above may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), FPGA, gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
determining, for a first network, first activity information for shared usage of a first portion of a spectrum allocated to the first network with at least one second network; and
causing the first activity information to be sent to at least one base station of said second network.

2.-3. (canceled)

4. The method according to claim 1, wherein the first portion is an inter-operator sharing portion.

5. The method according to claim 1, wherein the spectrum allocated to the first network comprises a second portion.

6. The method according to claim 5, wherein the second portion is an intra-operator sharing portion.

7. The method according to claim 6, further comprising causing shared usage of the intra-operator portion with the at least one second network in dependence of a request from the second network.

8.-10. (canceled)

11. The method according to claim 1, comprising determining the first activity information in dependence of at least one of cell density, relative traffic volumes of a cell and interference levels of a cell.

12.-17. (canceled)

18. A method comprising:
receiving first activity information associated with a first network; and
determining, for a first portion of a spectrum shared between said first network and at least one second network, if said second network is to change said share of said spectrum in dependence of said first activity information.

19. (canceled)

20. The method according to claim 18 further comprising causing a request to be sent to the first network for a change in said share of said spectrum.

21. The method according to claim 18, wherein the first portion of the spectrum is at least a portion of an inter-operator sharing portion.

22.-24. (canceled)

25. The method according to claim 18 further comprising requesting selection of a second portion of the spectrum shared between the first network and the second network.

26. The method according to claim 25, further comprising receiving a request to stop using the second portion of the spectrum.

27. The method according to claim 25, wherein the second portion comprises at least a portion of an intra-operator sharing part.

28. (canceled)

29. The method according to claim 18 wherein activity information is dependent on at least one cell density of relative traffic volumes of a cell and interference levels of a cell.

30.-31. (canceled)

32. An apparatus comprising:
at least one processor and at least one memory including a computer program code, the at least one memory and the computer program code configured to, with the at least one processor, cause the apparatus at least to:
determine, for a first network, first activity information for shared usage of a first portion of a spectrum allocated to the first network with at least one second network; and
cause the first activity information to be sent to at least one base station of said second network operated by one of the plurality of operators.

33.-46. (canceled)

47. An apparatus comprising:
at least one processor and at least one memory including a computer program code, the at least one memory and the computer program code configured to, with the at least one processor, cause the apparatus at least to:
receive first activity information associated with a first network; and
determine, for a first portion of a spectrum shared between said first network and at least one second network, if said second network is to change said share of said spectrum in dependence of the first activity information.

48.-58. (canceled)

59. A computer program embodied on a computer-readable storage medium, the computer program comprising program code for controlling a process to execute a process, the process comprising:
determining, for a first network, first activity information for shared usage of a first portion of a spectrum allocated to the first network with at least one second network; and
causing the first activity information to be sent to at least one base station of said second network operated by one of the plurality of operators.

60. A computer program embodied on a computer-readable storage medium, the computer program comprising program code for controlling a process to execute a process, the process comprising:
receiving first activity information associated with a first network; and
determining, for a first portion of a spectrum shared between said first network and at least one second network, if said second network is to change said share of said spectrum in dependence of the first activity information.
